(19) United States
(12) Patent Application Publication
(10) Pub. No.: US 2026/0065359 A1
(43) Pub. Date: Mar. 5, 2026

(54) IN-GAME MEDIA CONTENT CAPTURE IN A VIRTUAL ENVIRONMENT WITH INSPECT AND BUY FEATURES

(71) Applicant: Roblox Corporation, San Mateo, CA (US)

(72) Inventors: Garima SINHA, San Mateo, CA (US); Irene NGUYEN, San Mateo, CA (US); Darragh Michael GRIFFIN, San Mateo, CA (US); Joseph ADDONA, San Mateo, CA (US); Soham KUDTARKAR, San Mateo, CA (US); Fiona LI, San Mateo, CA (US); Teakay WU, San Mateo, CA (US)

(73) Assignee: Roblox Corporation, San Mateo, CA (US)

(21) Appl. No.: 19/318,982

(22) Filed: Sep. 4, 2025

Related U.S. Application Data
(60) Provisional application No. 63/691,299, filed on Sep. 5, 2024.

(51) Int. Cl. G06Q 30/0601; A63F 13/77

(52) U.S. Cl. CPC G06Q 30/06431; A63F 13/77

(57) ABSTRACT

Methods, computer-readable media, and systems provide ways to capture and store in-game media content in a virtual experience, comprising: receiving a request to capture the in-game media content; capturing the in-game media content, associated with a temporary content identifier; storing the captured in-game media content in a temporary storage of the user device; detecting an overflow of a storage capacity of the temporary storage; in response to detecting the overflow of the storage capacity, prompting a developer to select a piece of the captured in-game media content to remove from the temporary storage via a callback function; in response to receiving developer selection of the piece of in-game media content to remove, removing the piece of in-game media content; and in response to no developer selection in response to the prompting, automatically selecting the piece of in-game media content to remove and removing the piece of in-game media content.

### CROSS-REFERENCE TO RELATED APPLICATIONS

This application claims priority under 35 U.S.C. § 119 (e) to U.S. Provisional Patent Application No. 63/691,299, entitled “IMAGE CAPTURE IN A VIRTUAL ENVIRONMENT WITH INSPECT AND BUY FEATURES,” filed on Sep. 5, 2024, the content of which is incorporated herein in its entirety.

### TECHNICAL FIELD

This disclosure relates generally to computer graphics, and more particularly but not exclusively, relates to methods, systems, and computer readable media that facilitate in-game media content capturing, where the in-game media content capturing may also enable inspect and buy features.

### BACKGROUND

In three-dimensional (3D) modeling and game development (or for other contexts of virtual experiences), developers may wish to capture in-game media content (such as screenshots) on demand and have capabilities to easily store and manage such in-game media content. It may be preferable not to use storage on a user device so as to conserve local storage space. Therefore, developers may store captured in-game media content from memory and write the in-game media content to a server-side disk.

This approach can lead to substantial memory usage since not all in-game media content may be transferred to a server in limited bandwidth scenarios. Additionally, current in-game media content mechanisms are restricted to images, and lack effective management of video content (e.g., video recordings of a virtual experience or game). Current in-game media content mechanisms also have limitations related to content sharing in a virtual environment (such as a virtual experience platform).

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform or control performance of the actions.

According to one aspect, a computer-implemented method to capture and manage storage of in-game media content in a virtual experience is provided, the method comprising: receiving, at a user device, a request to capture the in-game media content while an avatar associated with a user of the user device participates in the virtual experience; capturing the in-game media content on the user device, wherein the captured in-game media content is associated with a temporary content identifier (ID) and includes one or more pieces of the in-game media content; storing the captured in-game media content in a temporary storage of the user device, the temporary storage configured to provide a storage location to store the captured in-game media content until the user of the user device instructs the user device to store the captured in-game media content in a persistent storage of the user device; detecting an overflow of a storage capacity of the temporary storage of the user device; in response to detecting the overflow of the storage capacity, prompting a developer to select a particular piece of the captured in-game media content to remove from the temporary storage wherein the developer selection is via a callback function that has as a parameter a content ID of the particular piece of the captured in-game media content to remove; in response to receiving developer selection of the particular piece of the captured in-game media content to remove, removing the particular piece of the captured in-game media content from the temporary storage using the content ID of the particular piece of the captured in-game media content to access the particular piece of the captured in-game media content when removing the particular piece of the captured in-game media content; and in response to no developer selection in response to the prompting, automatically selecting the particular piece of the captured in-game media content to remove and removing the particular piece of the captured in-game media content from the temporary storage.

Various implementations of the computer-implemented method are described herein.

In some implementations, the method further comprises performing additional iterations of prompting and removing at least one other piece of the captured in-game media content until the temporary storage of the user device does not overflow the storage capacity.

In some implementations, the particular piece of the captured in-game media content comprises a screenshot of a display screen of the user device captured while the user of the user device participates in the virtual experience.

In some implementations, the particular piece of the captured in-game media content comprises a video file that includes captured video of a display screen of the user device and associated audio captured while the user of the user device participates in the virtual experience.

In some implementations, the video file is deleted from the temporary storage after a user session of the virtual experience ends, the user shares the video file, or the user saves the video file.

In some implementations, the automatically selecting the particular piece of the captured in-game media content to remove is based on respective durations for which individual pieces of in-game media content are present in the temporary storage.

In some implementations, the particular piece of the captured in-game media content has a longest duration from among the respective durations for which individual pieces of in-game media content are present in the temporary storage.

In some implementations, the automatically selecting the particular piece of the captured in-game media content to remove is based on respective access times for which individual pieces of in-game media content are accessed from the temporary storage.

In some implementations, the method further comprises providing a function to the developer that takes a content ID of a piece of the captured in-game media content as a parameter without detecting the overflow and removes the piece of the captured in-game media content corresponding to the content ID.

In some implementations, the method further comprises: receiving a request from the user of the user device to store a first piece of the captured in-game media content in a persistent storage of the user device; copying the first piece of the captured in-game media content from the temporary storage to the persistent storage; and after the copying, removing the first piece of the captured in-game media content from the temporary storage.

According to another aspect, a non-transitory computer-readable medium is provided. The non-transitory computer-readable medium has instructions stored thereon that, responsive to execution by a processing device, causes the processing device to perform or control performance of operations to capture and manage storage of in-game media content in a virtual experience, the operations comprising: receiving, at a user device, a request to capture the in-game media content while an avatar associated with a user of the user device participates in the virtual experience; capturing the in-game media content on the user device, wherein the captured in-game media content is associated with a temporary content identifier (ID) and includes one or more pieces of the in-game media content; storing the captured in-game media content in a temporary storage of the user device, the temporary storage configured to provide a storage location to store the captured in-game media content until the user of the user device instructs the user device to store the captured in-game media content in a persistent storage of the user device; detecting an overflow of a storage capacity of the temporary storage of the user device; in response to detecting the overflow of the storage capacity, prompting a developer to select a particular piece of the captured in-game media content to remove from the temporary storage wherein the developer selection is via a callback function that has as a parameter a content ID of the particular piece of the captured in-game media content to remove; in response to receiving developer selection of the particular piece of the captured in-game media content to remove, removing the particular piece of the captured in-game media content from the temporary storage using the content ID of the particular piece of the captured in-game media content to access the particular piece of the captured in-game media content when removing the particular piece of the captured in-game media content; and in response to no developer selection in response to the prompting, automatically selecting the particular piece of the captured in-game media content to remove and removing the particular piece of the captured in-game media content from the temporary storage.

Various implementations of the non-transitory computer-readable medium are described herein.

In some implementations, the operations further comprise performing additional iterations of prompting and removing at least one other piece of the captured in-game media content until the temporary storage of the user device does not overflow the storage capacity.

In some implementations, the particular piece of the captured in-game media content comprises a screenshot of a display screen of the user device captured while the user of the user device participates in the virtual experience.

In some implementations, the particular piece of the captured in-game media content comprises a video file that includes captured video of a display screen of the user device and associated audio captured while the user of the user device participates in the virtual experience.

In some implementations, the video file is deleted from the temporary storage after a user session of the virtual experience ends, the user shares the video file, or the user saves the video file.

According to another aspect, a system is provided, the system comprising: a memory with instructions stored thereon; and a processing device, coupled to the memory, the processing device configured to access the memory and execute the instructions, wherein the instructions cause the processing device to perform or control performance of operations to capture and manage storage of in-game media content in a virtual experience, the operations comprising: receiving, at a user device, a request to capture the in-game media content while an avatar associated with a user of the user device participates in the virtual experience; capturing the in-game media content on the user device, wherein the captured in-game media content is associated with a temporary content identifier (ID) and includes one or more pieces of the in-game media content; storing the captured in-game media content in a temporary storage of the user device, the temporary storage configured to provide a storage location to store the captured in-game media content until the user of the user device instructs the user device to store the captured in-game media content in a persistent storage of the user device; detecting an overflow of a storage capacity of the temporary storage of the user device; in response to detecting the overflow of the storage capacity, prompting a developer to select a particular piece of the captured in-game media content to remove from the temporary storage wherein the developer selection is via a callback function that has as a parameter a content ID of the particular piece of the captured in-game media content to remove; in response to receiving developer selection of the particular piece of the captured in-game media content to remove, removing the particular piece of the captured in-game media content from the temporary storage using the content ID of the particular piece of the captured in-game media content to access the particular piece of the captured in-game media content when removing the particular piece of the captured in-game media content; and in response to no developer selection in response to the prompting, automatically selecting the particular piece of the captured in-game media content to remove and removing the particular piece of the captured in-game media content from the temporary storage.

Various implementations of the system are described herein.

In some implementations, the operations further comprise performing additional iterations of prompting and removing at least one other piece of the captured in-game media content until the temporary storage of the user device does not overflow the storage capacity.

In some implementations, the particular piece of the captured in-game media content comprises a screenshot of a display screen of the user device captured while the user of the user device participates in the virtual experience.

In some implementations, the particular piece of the captured in-game media content comprises a video file that includes captured video of a display screen of the user device and associated audio captured while the user of the user device participates in the virtual experience.

In some implementations, the video file is deleted from the temporary storage after a user session of the virtual experience ends, the user shares the video file, or the user saves the video file.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that includes functionality to manage the capture and storage of in-game media content, as well as the analysis of such in-game media content to provide inspect and buy features, in accordance with some implementations.

FIG. 2 is a diagram of an example system architecture that includes functionality to manage the capture and storage of in-game media content, in accordance with some implementations.

FIG. 3 is a flowchart of a method to capture and manage the storage of in-game media content, in accordance with some implementations.

FIG. 4 is a flowchart of a method to manage the storage and deletion of in-game media content, in accordance with some implementations.

FIG. 5 is a flowchart of a method to permit a developer to delete in-game media content from a temporary storage of a user device, in accordance with some implementations.

FIG. 6 is a flowchart of a method to permit a user to move in-game media content from a temporary storage of a user device to a persistent storage of the user device, in accordance with some implementations.

FIG. 7 is a flowchart of a method to identify and store information about avatars present in in-game media content, in accordance with some implementations.

FIG. 8 is a flowchart of a method to use stored information about avatars to provide inspect/buy functionality, in accordance with some implementations.

FIG. 9 is a flowchart of a method to manage sharing of stored content across different participants, in accordance with some implementations.

FIG. 10 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

The present disclosure is directed towards, inter alia, providing an in-game media content capture application programming interface (API) or another automatic mechanism to manage the acquisition and storage of in-game media content. The mechanism may also enable analysis of the in-game media content to provide inspect and buy features for the in-game media content. For example, the mechanism may include features to remove unused captures upon request as well as to automatically remove temporary in-game media content, e.g., if a client device that stores the in-game media content in memory is constrained (e.g., available memory falls below a threshold and/or negatively affects performance of the client device).

The mechanism may also manage memory aspects of video captures and content sharing at the server (that hosts one or more instances of a virtual experience), virtual experience (individual experiences/games in which the in-game media content is captured), and virtual experience environment (the environment that hosts multiple virtual experiences) levels. Such a virtual environment is also referred to herein as a virtual experience platform.

The inspect and buy features may include taking an in-game media content capture (for example, screenshot capture and/or video capture), determining which avatars are visible in the captured in-game media content, serializing objects for the identified avatars, and saving the metadata (e.g., identification of avatars and/or objects in the in-game media content) at the server.

The metadata from the in-game media content may be used to provide an entry point for users to perform inspect and buy, such as to inspect and buy an avatar outfit (e.g., a combination of avatar accessories) or a particular accessory or look, based on the metadata that identifies various components of an avatar outfit in the in-game media content.

The description of the features in the context of games and game functionality is merely an example, and the features can be adapted to other types of virtual experiences that do not necessarily involve games.

### Problem

Certain APIs may permit developers to capture in-game media content (such as screenshots and/or video) on demand. It may be preferable not to consume persistent storage on a user's device without the user opting in. Hence, the in-game media content may be stored in a temporary storage (such as a memory or another temporary data repository). Developers can prompt the user to save this in-game media content, which removes the in-game media content from memory and writes the in-game media content to disk. Some developers have use cases that do not involve the user eventually saving the in-game media content, and so the potential memory usage in the temporary storage is possibly unbounded.

Another problem addressed herein is that current ways of capturing and managing in-game media content in a virtual experience do not enable easy identification of objects (virtual objects) illustrated in the in-game media content. At present, developers of individual virtual experiences rely on storing in-game media content themselves (for example, at a storage under the control of the developer), with no environment support.

Accordingly, captured in-game media content cannot be used directly to permit users to discover virtual objects illustrated in the in-game media content (inspect) or to acquire such virtual objects (buy) from the virtual environment. Consequently, visual discovery of virtual objects is constrained and users may have to perform searches, browse a catalog, or use other techniques to identify virtual objects and to buy virtual objects that users see in a virtual experience or in-game media content. This approach is wasteful of computational resources and also does not enable accurate and complete discovery of virtual objects.

### Solution

To aid in capturing and managing in-game media content, various implementations presented herein provide an application programming interface (API) or other mechanisms that help to manage temporary storage (such as memory or another temporary storage repository) and persistent storage on a client device that is utilized for in-game media content (or other type of content), including images and/or videos. Additionally, some implementations also facilitate content sharing. With respect to inspect and buy features, some implementations provide automatic ways to provide inspect and buy functionality.

### Temporary Capture Cleanup

An in-game media content capture API (or another mechanism) that is a part of an overall capture service in a virtual environment may permit developers to capture in-game media content on demand (for example, upon a command from a user participating in a particular virtual experience provided by the developer). The in-game media content capture API may provide a temporary content identification (ID) that can be used to refer to and/or manage the in-game media content when subsequently accessing or otherwise using the corresponding in-game media content.

The in-game media content capture is stored temporarily in a temporary storage. The temporary storage may be associated with a user device, such as a memory or another temporary storage of the user device. The temporary storage may also be a temporary storage provided by another portion of the virtual environment. Such a temporary storage may be managed by a client application that runs the virtual experience in which the in-game media content is captured. Developers can prompt the user to save this captured in-game media content, which removes the captured in-game media content from temporary storage and writes the captured in-game media content to persistent storage (at the user device or elsewhere).

Sometimes, the user does not eventually save the in-game media content. The memory usage in such situations (for such developers and virtual experiences) is potentially unbounded. Therefore, there may be memory capacity problems as the amount of in-game media content consume grows. Hence, developers may only be able to provide temporary storage for some of the in-game media content. As a solution, APIs are provided to overcome the memory capacity issue in a technically advantageous manner.

One of these APIs may be an API to provide a remove temporary capture capability (based on a content ID). The remove temporary capture API may provide an easy way to remove unused in-game media content for a developer (performed manually). For example, a developer of a virtual experience may make a call via the remove temporary capture API (provided by the virtual environment that manages the client application within which the in-game media content is captured) to cause the client application to delete one or more pieces of in-game media content (identified in the API call using the relevant content ID) and free up memory. Such a call may occur when the temporary storage is not subject to an overflow condition.

Another API may be an API for performing an on temporary capture removing function (based on a content ID). Such a function may involve a callback function passed to a developer. By using such a callback function, a developer can instruct the client application to automatically remove temporary captures if there is memory pressure at the temporary storage. For example, the function provides a callback to developers to choose the temporary capture to remove. The removal may continue until the memory pressure or overflow situation is resolved.

If the callback function is not implemented by the developer (e.g., the developer does not choose a temporary capture that is to be removed using the callback), the client application may implement a heuristic or rules-based approach to select one or more captures (in-game media content) to delete and free up memory.

The heuristic may remove an automatically chosen temporary in-game media content. For example, the oldest capture or oldest temporary piece of in-game media content (relative to a current time) may be removed. As an alternative or additionally, the least frequently accessed capture may be removed. As another alternative or additionally, the capture having an oldest access time may be removed.

Other heuristics may be used to determine how to automatically choose which capture to delete. For example, it may be possible to use a machine learning (ML) model that is trained to identify a metric of deleting the items of content based on predicted likelihood of use, amount of memory freed up, or other criteria.

### Capture APIs for Video Content

In-game media content APIs can also be used for video content in addition to snapshots, e.g., video snapshots of a virtual experience of a short duration (e.g., 5 seconds, 20 seconds, 2 minutes, etc.). Such video content may also include audio and may be taken at various frame rates (e.g., 30 frames per second, 60 frames per second, etc.).

Events that occur immediately before a capture begins and occur after a capture terminates may be detected for video in-game media content. A capture type argument may be provided, which may have an enumerated value, specifying the relevant capture type (e.g., video or image/screenshot in-game media content). Such an enumerated value may help distinguish between still images and videos, as well as videos that include audio and those videos that do not.

Lower end devices (e.g., devices having limited computing resources) may be more likely to experience out-of-memory (OOM) issues if a captured snapshot (e.g., from a video file) cannot be written to disk. To resolve this problem, a temporary caching technique is utilized in which it is possible to write video files captured by the developer until either the end of the session (for example, a user's gameplay of a virtual experience), until the user decides to share or save the video file, or until one or more captured video files are subjected to cleanup. In some implementations, the cache may be populated for one session and hence it may be possible to have a basic eviction policy (e.g., removing all previous files at the start of each new session (or a subset of previous files chosen based on another eviction policy)).

For example, such an API may return, as an enumerated value, a video capture result value. For example, the enumerated values may correspond to one of success (e.g., enumerated value of 0), time limit exceeded (e.g., enumerated value of 1), encoding failed (e.g., enumerated value of 2), and out of memory (e.g., enumerated value of 3). These are illustrative examples, and other enumerated values may be used for the video capture result (or different values could correspond to different situations. APIs may also be provided to developers of virtual experiences to initiate or stop video capturing from corresponding virtual experiences, to specify how to store the captured video, etc.

### Content Sharing

Some implementations may enable content sharing across a variety of different scopes. One scope is the server scope. According to the server scope, users can share content to other users in the same game server (e.g., that hosts the virtual experience from which in-game media content is captured). Another scope is the experience scope.

Users can share content across a given experience (to other participants within the same virtual experience, e.g., co-players within the same instance, and/or players in other instances of the virtual experience). Another scope is the platform scope (across the virtual experience platform or virtual environment). Users can share content captured in an experience on the virtual environment or virtual experience platform.

To enable content sharing for users in the same game server it may be possible to rely on a client->game server->client replication pipeline. The approach presented may be less complex to implement compared with the alternative of uploading the captures to the virtual environment, due to merely having to store images for the lifetime of a game server.

Such approaches as provided for images may need adaptation to work for video. Video captures are to be uploaded to the content delivery network (CDN) to facilitate any content sharing, even if content sharing is within just one game server. A developer API to perform content sharing within a corresponding experience may be as follows. For example, there may be a method to prompt to upload a captured video, with parameters of content ID, and information about success or failure of an upload result may be provided.

For a persistent upload mechanism, an API like the above may be sufficient. Additionally, if there is a condition to limit the lifetime of the content (to save on storage costs), an additional API may be provided to manage the lifetime of the content (as well as return the expiry date in the initial result). For example, the expiry date may be a date and time value. There may be a method to get such capture expiration information asynchronously based on a content ID of the relevant content.

The implementation for both single server sharing and cross experience content sharing may be similar, except for moderation and content lifetime aspects. In some implementations, the in-game media content lifetime may be limited to the time that a game server stays running. For example, the lifetime may be limited to last until the server is terminated. Such a termination event may occur once all participants exit the virtual experience instance in which the in-game media content was captured. If an implementation is configured to limit access to users in the same game instance, a new content ID type for this particular use case may be created.

### Experience Feed

An experience feed may be accessible in-game. For example, an experience may be a specific virtual place in a virtual environment. An experience feed may be a mechanism to provide a user with an interactive way to manage information for the experience. Experience feed APIs may include the following capabilities. As one example capability, the experience feed may fetch all content (or a specific subset of the content) and format the content into one or more pages. As another example capability, the experience feed may delete content. As yet another example capability, the experience feed may filter content. As still another example capability, the experience feed may pin content to specific spots (within the user interface). For example, the developer can choose what is illustrated initially.

As another example capability of the experience feed, the experience feed may re-share content on behalf of the experience/group. As yet another example capability, the experience feed may re-rank content. In particular, the experience feed may just be able to add weighting, not fully override the ranking. As still another example, the experience feed may be able to get metrics for the content. Such metrics may include views, reactions, and comments (with source) for the content.

Similarly to how an avatar editor service may be a wrapper around a lot of the APIs provided in a virtual environment, the APIs to provide feed management may be made available through a unified capture service. This approach may provide for the creation of a plugin to make feed customization available in a virtual environment builder program.

In some implementations, it may also be helpful to permit developers to prompt users to post to the experience feed on the virtual environment. For example, there may be a technique for a developer to prompt a user to request that the user capture and post to the experience feed (or on a corresponding user profile) as captured content that uses a content ID.

### Inspect and Buy for Captures

A user may open the in-game menu while in a virtual experience and tap an inspect control for an avatar in the virtual experience (that may belong to another user). The user can view a list of the items (avatar accessories) currently worn by that avatar. Tapping on an item presents an option to try on the item (on the user's own avatar) or purchase the item if available.

For captures (from in-game media content), a useful flow may be as follows. The user takes a screenshot from in-game media content (video in-game media content may also be available). Here, there may be a user instruction to take the screenshot. The captures functionality may determine which avatars are prominently visible in the capture. For screenshots this may be done using an automated avatar identification module. The identification may establish if a given avatar is present in screenshots. For example, the identification may use an avatar identification machine learning model or another avatar identification technique.

Once the identification is completed, humanoid description objects associated with the identified avatars may be serialized to generate serialized avatar descriptions that represent these identified avatars. The objects may be associated with captured avatar metadata. The captured avatar metadata may be saved for every capture from in-game media content (whether a screenshot capture or a video capture). When the user posts a capture, this metadata (e.g., a humanoid description object) is sent to a backend (such as a backend server).

Such metadata may be used for future determination related to an identified avatar subsequently. If avatar outfit metadata exists as corresponding stored avatar metadata when a capture is viewed subsequently, a corresponding entry point to inspect and buy (I&B) functions is presented. The I&B functions may enable users to view in-game media content and identify and purchase items (e.g., avatar accessories or other virtual objects) illustrated in the in-game media content.

### Inspect and Buy (I&B)

In this aspect, a user may inspect a capture based on a humanoid description. This aspect also provides support for features like detecting that an item is part of a bundle (e.g., a shirt and trousers bundle, a shoes and socks bundle, etc.).

The aspect may be transformed into a package to use in an application (app). The package also makes a few assumptions about running in-experience. The package uses an in-experience localization table. The package also uses in-experience prompt purchase flow. This approach may test for security/policy attributes based on a localization parameter.

An alternative is to use a currently wearing UI and/or item tile UI with reference to an avatar. This approach has certain advantages. An item tile component from a design system for a user interface in a virtual environment is likely everything that is necessary for displaying items. A direct way to purchase items that an avatar (in the capture) is wearing may be provided, items that are part of bundles.

Both options may incorporate certain features. For example, both options may include avatar metadata capture/storage features. This content may include screenshots only, or other types of in-game media content. The in-game media content may also include video, though implementing video may be more complicated. It may also be relevant to provide for post endpoint changes and metadata storage. It may also be useful to provide a feed for UI inspect and buy entry point mechanisms.

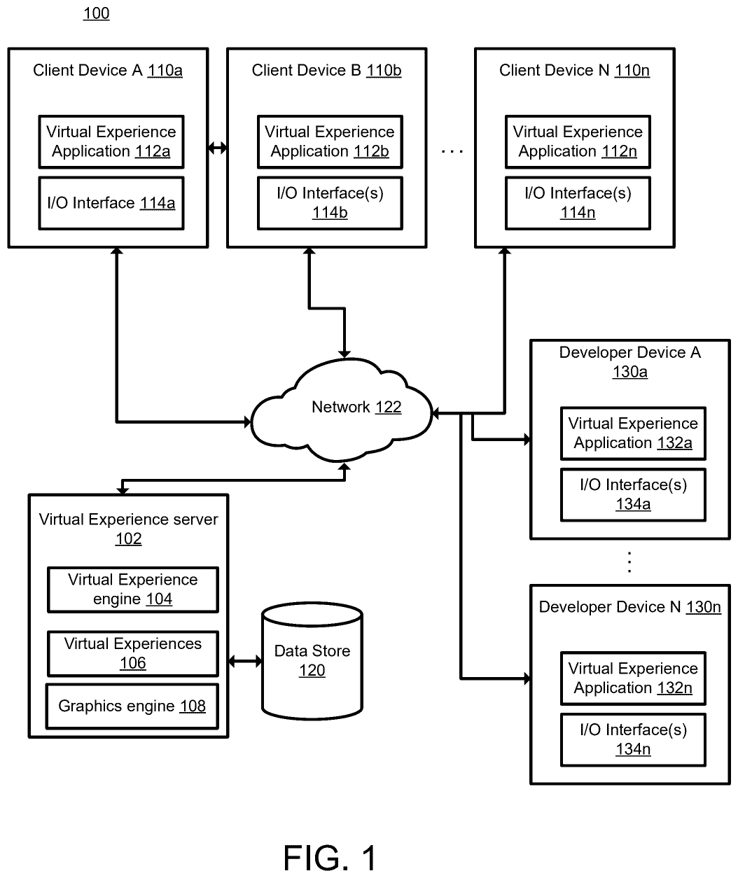

FIG. 1 is a diagram of an example system architecture that includes functionality to manage the capture and storage of in-game media content, as well as the analysis of such in-game media content to provide inspect and buy features, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

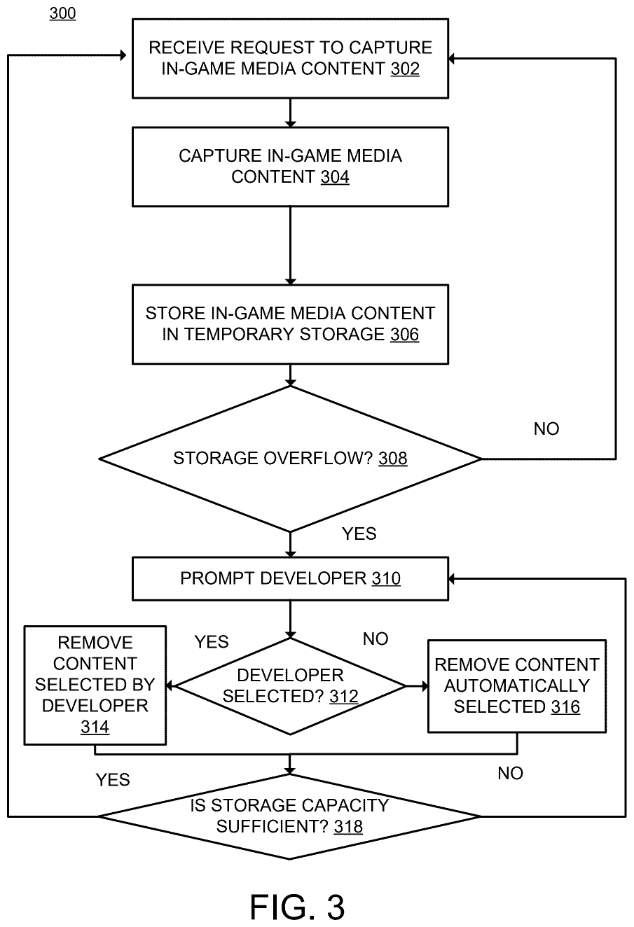

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 may perform one or more of the operations described below in connection with the flowcharts shown in FIGS. 3-9 or other operations described herein. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s)); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata (e.g., text content of chat with each message having a corresponding sender and recipient(s)); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.” In some contexts, a user may be a system administrator or other entity that has privileges/permission that are different from and/or in addition to an end user.

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 110 may be used.

One or more characters (also referred to as an “avatar” or “model” herein) may be associated with a user where the user may control the character to facilitate a user's interaction with the virtual experiences 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users access to simplified 3D virtual object models that are represented by a mesh of a low polygon count (e.g., between about 20 and about 30 polygons).

In some implementations, the user may also control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

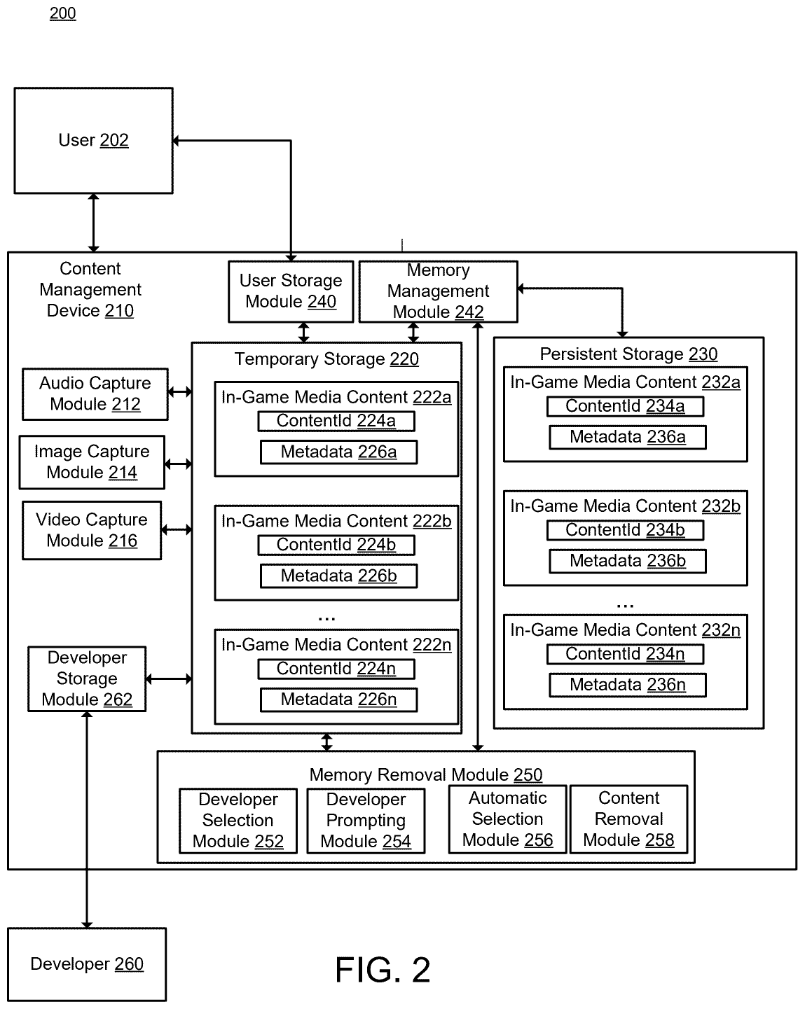

FIG. 2 is a diagram 200 of an example system architecture that includes functionality to manage the capture and storage of in-game media content, in accordance with some implementations. FIG. 2 illustrates a user 202 and a developer 260 that interact with a content management device 210. The content management device 210 may be implemented in various ways. In some implementations, the content management device 210 is implemented using various hardware at a user device. In other implementations, the content management device 210 is implemented partially using various hardware at a user device and partially using various hardware provided at a virtual environment. In some implementations, the content management device 210 may be implemented by the virtual experience server 102 and/or by some other device(s) that can reside in the system architecture 100 of FIG. 1.

For example, in some implementations, portions of the content management device 210 such as various modules used to capture in-game media content and a temporary storage 220 are implemented at the virtual environment, while a persistent storage 230 is implemented at a user device. In some implementations, the content management device 210 is wholly implemented at the user device and the user 202 and the developer 260 simply interact with the content management device 210 to control what information is stored in the temporary storage 220 and what information is stored in the persistent storage 230.

The content management device 210 includes various modules and components that permit user 202 and developer 260 to capture and store in-game media content. The various modules/components can be embodied by software or other computer-readable instructions stored on a computer-readable medium and executable by one or more processors. However, in some implementations, the processor does not directly provide (or does not provide at all) some of the recited features. As an example, in some implementations, the content management device 210 includes an audio capture module 212, an image capture module 214, and a video capture module 216. In some implementations, only some of these components are present. For example, in some implementations, only the image capture module 214 is present and used to capture in-game media content.

The content management device 210 also includes a temporary storage 220 and a persistent storage 230. As noted, the temporary storage 220 and the persistent storage 230 may be provided in a variety of ways. The content management device 210 also includes a user storage module 240 and a memory management module 242, as well as a memory removal module 250. The memory removal module 250 may include additional components that participate in memory removal, including a developer selection module 252, a developer prompting module 254, an automatic selection module 256, and/or a content removal module 258.

The content management device 210 may receive an instruction from the user 202 and/or the developer 260 to capture in-game media content. For example, the user 202 may send an instruction to the user storage module 240 or the developer 260 may send an instruction to the developer storage module 262. The user storage module 240 or the developer storage module 262 may send an instruction to the temporary storage 220, which receives in-game media content from audio capture module 212, image capture module 214, and/or video capture module 216.

Such an instruction may cause the content management device 210 to capture in-game media content. Such capturing may use the audio capture module 212, the image capture module 214, and/or the video capture module 216. By using these modules, the content management device 210 may capture one or more pieces of in-game media content, including screenshots, video, and/or audio.

The temporary storage 220 initially stores the captured in-game media content until the captured in-game media content is saved by the user, another relevant event occurs (for example, a game session ends, or a user shares the content), or the in-game media content is evicted (such as due to a memory issue with capacity of the temporary storage 220). For example, temporary storage 220 includes n pieces of in-game media content (where n is a natural number), such as in-game media content 222a, associated with content ID 224a and metadata 226a, in-game media content 222b, associated with content ID 224b and metadata 226b, through in-game media content 222n, associated with content ID 224n and metadata 226n.

Here, each content ID 224 is a unique identifier that permits access to in-game media content, such as by user 202 or developer 260, or another portion of content management device 210, such as memory removal module 250. Each piece of metadata 226 may store properties of the in-game media content 222 that may be used in various ways. For example, the metadata may provide information about how long the in-game media content 222 has been present in the temporary storage 220. The metadata may also provide information about when the in-game media content 222 was last accessed. Such information may be useful when automatically selecting in-game media content to remove.

The memory management module 242 may manage transfer of data from temporary storage 220 to persistent storage 230. For example, the user storage module 240 may receive a command from the user 202 to transfer one or more pieces of in-game media content 222 to persistent storage 230. Such a request causes user storage module 240 and memory management module 242 to work with temporary storage 220 and persistent storage 230 to transfer in-game media content accordingly.

The persistent storage 230 stores the captured in-game media content once the user opts-in to storing the captured in-game media content. For example, persistent storage 230 includes n pieces of in-game media content (where n is a natural number) such as in-game media content 232a associated with content ID 234a and metadata 236a, in-game media content 232b associated with content ID 234b and metadata 236b, through in-game media content 232n associated with content ID 234n and metadata 236n. Each content ID 234 and each metadata 236 are similar to corresponding information in the temporary storage 220.

As temporary storage 220 manages in-game media content 222, memory management module 242 tracks the storage capacity of temporary storage 220. If an overflow event or another event indicating memory pressure occurs (temporary storage 220 cannot store all of the in-game media content 222 that temporary storage 220 is being requested to store), memory management module 242 invokes memory removal module 250. Memory removal module 250 manages in-game media content to retain as much in-game media content as possible, given the storage constraints of temporary storage 220.

Memory removal module 250 includes developer selection module 252, developer prompting module 254, automatic selection module 256, and content removal module 258. The developer prompting module 254 may prompt developer 260 to select in-game media content 222 to remove from temporary storage 220. The developer may then select in-game media content to remove using developer selection module 252, such as by using a callback function.

Alternatively or additionally, if the developer does not select the in-game media content to remove, or in some implementations that circumvent a developer, in-game media content is selected to remove using an automatic selection module 256. The automatic selection module 256 selects in-game media content to remove based on various heuristics, such as various metadata corresponding to the in-game media content. Once the developer selection module 252 or the automatic selection module 256 has established which in-game media content to remove, content removal module 258 removes that content from temporary storage 220 to alleviate the memory usage.

Memory removal module 250 may continue to remove content in this manner until there is sufficient space in temporary storage 220. All of the removed content may be selected by a developer, all of the removed content may be removed automatically, or the removed content may be a combination. Additionally, if the memory removal module 250 establishes that a user has saved in-game media content while the memory removal module is automatically removing in-game media content, this may obviate the performance of additional removal of in-game media content.

FIG. 3 is a flowchart of a method 300 to capture and manage the storage of in-game media content, in accordance with some implementations. Method 300 may begin at block 302.

At block 302, a request to capture in-game media content is received by a user device. Such in-game media content may include a screenshot and/or captured video (with or without audio). The request may occur while an avatar associated with a user of the user device participates in a given virtual experience. The request may be received from a user of the user device.

Alternatively or additionally, the request may be received from a developer associated with the given virtual experience. The request to capture the in-game media content is intended to provide a record of user interaction with the virtual experience. Such records may be used in a variety of ways as discussed herein. There may also be issues with memory overflow, and method 300 manages these issues. Block 302 may be followed by block 304.

At block 304, in-game media content is captured. For example, the captured in-game media content may include audio, images (e.g., screenshots) and/or video. For example, the captured in-game media content may be captured from the perspective of an avatar associated with the user device. For example, the captured in-game media content may be a capture of a screenshot presented to the user of the user device as the user device interacts with the virtual experience. Likewise, the captured in-game media content may be a capture of video presented to the user of the user device as the user device interacts with the virtual experience. Such video may or may not be accompanied by audio presented to the user's avatar as the user's avatar interacts with the virtual experience. Block 304 may be followed by block 306.

At block 306, the captured in-game media content is stored in a temporary storage. As discussed, the temporary storage may have various aspects. In some implementations, the temporary storage may be a memory or another form of storage maintained at a user device configured to provide a storage location to store the captured in-game media content until the user of the user device instructs the user device to store the captured in-game media content in a persistent storage of the user device.

The temporary storage is not limited to being a temporary storage provided by the user device, and the temporary storage may also be an alternative temporary storage provided by the virtual environment or otherwise accessible to a developer to use as a place to store captured in-game media content until the in-game media content is saved in persistent storage. The temporary storage has a finite capacity, and it may be necessary to take action when in-game media content is captured, but there is no space to maintain all of the in-game media content in the temporary storage. Block 306 may be followed by block 308.

At block 308, it is determined if the storage capacity of the temporary storage is experiencing an overflow. As noted, the temporary storage has a finite capacity to store the in-game media content while the temporary storage is waiting to persist the in-game media content. It is determined if the in-game media content that was stored in block 306 causes the total amount of in-game media content to overflow the storage capability of the temporary storage. Explained in another way, block detects if the temporary storage has insufficient capacity for the temporary in-game media content. If so (there is an overflow), block 308 is followed by block 310. If not, block 308 is followed by block 302, such that another request to capture in-game media content may be received.

At block 310, a developer is prompted to select content to be removed from the temporary storage. Such a prompt provides the developer with an opportunity to specify specific content to remove to avoid overflow of the temporary storage.

The developer may select a particular piece of the captured in-game media content to remove from the temporary storage wherein the developer section is via a callback function that has as a parameter a content ID of the particular piece of in-game media content to remove. A callback function is a function passed as an argument to another function.

The receiving function can then call back or execute the provided function at a later point. Here, the callback function permits the developer to specify a content ID that permits removal of the selected piece of in-game media content. Block 310 may be followed by block 312.

At block 312, it is determined whether the developer selected content to remove. If so, block 312 is followed by block 314 to remove that content. If not, block 312 is followed by block 316 to remove automatically selected content. It may be noted that in some implementations, block 308 is immediately followed by block 316, and when an overflow is detected at block 308, the method immediately proceeds to block 316 to remove automatically selected content.

At block 314, the content selected by the developer is removed. As noted above, this content may be selected using a callback function. In some implementations, one piece of content is removed. In other implementations, block 314 is followed by block 318 to confirm that enough content has been removed.

At block 316, automatically selected in-game media content is removed. In some implementations, one piece of content is removed. For example, the automatically selected in-game media content may be based on a duration of storage associated with the in-game media content. For example, the in-game media content that has been stored for the longest time may be evicted.

Alternatively or additionally, the automatically selected in-game media content may be based on when the in-game media content last accessed. For example, the in-game media content for which the longest time has elapsed since it was accessed may be evicted. The automatically selection may be based on other heuristics or based on other properties of the in-game media content such as a priority of the in-game media content. In other implementations, block 316 is followed by block 318 to confirm that enough content has been removed.

At block 318, it is determined if the storage capacity of the temporary storage is sufficient. If so, block 318 is followed by block 302, such that another request to capture in-game media content may be received. If not, block 318 is followed by block 310, to take steps to remove additional content.

It is assumed that at least one piece of in-game media content may be stored in temporary storage until the user confirms storing in-game media content. If not, the user may activate a setting in which actions may be taken to expand the capacity of the temporary storage (for example, increase an allotment of temporary storage or provide additional capacity for temporary storage at a new location or device). If it is not possible to expand temporary storage or immediately store the in-game media content in persistent storage, an error message may be provided or there may otherwise be interaction with a user and/or a developer to resolve the situation.

For example, one approach if it is not possible to store sufficient in-game media content in the temporary storage is to take steps to decrease the amount of space consumed by the content. For example, it may be possible to adjust the resolution, color depth, or compression settings of an image, or change a file format associated with the screenshot (for example, bitmap file formats such as JPEG, PNG, GIF, TIFF, BMP, RAW, etc.).

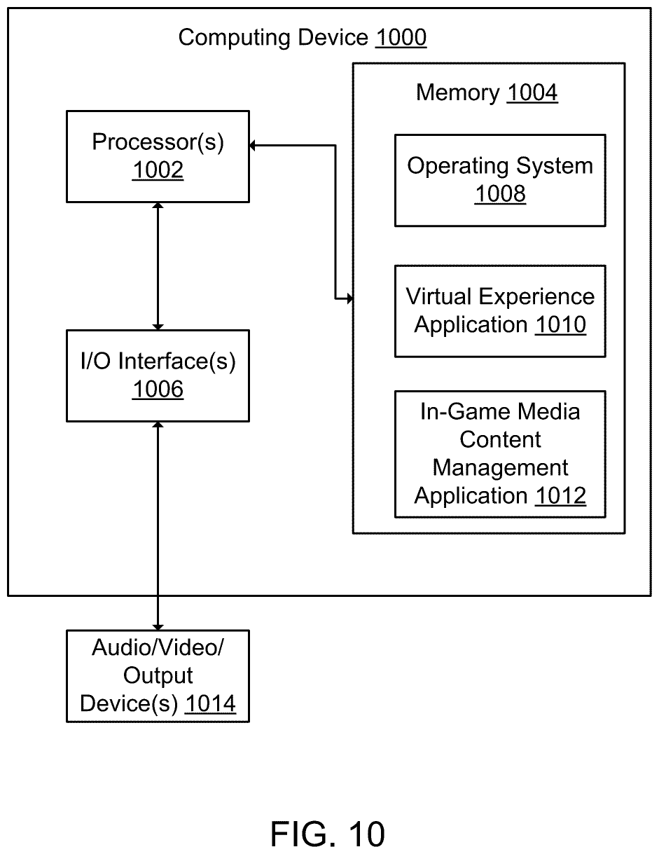

While FIG. 3 illustrates several operations provided in a certain order for carrying out method 300, it may be noted that there may be a variety of modifications to method 300 and/or other methods described herein. For example, other operations may be added, operations may be omitted, operations may be modified, operations may be combined, operations may be replaced by other operations, operations may be supplemented with other operations, or the order of operations may be varied. For example, the sequence of certain operations may be changed, or some of the operations may be carried out in parallel, as appropriate. Various operations as illustrated in method 300 and/or any other method described herein may be implemented by various hardware and/or software. For example, FIG. 1 and FIG. 10 illustrate various components that may implement the various operations provided in method 300, such as by being programmed using various appropriate software to configure the hardware to carry out method 300 and/or any other method described herein.

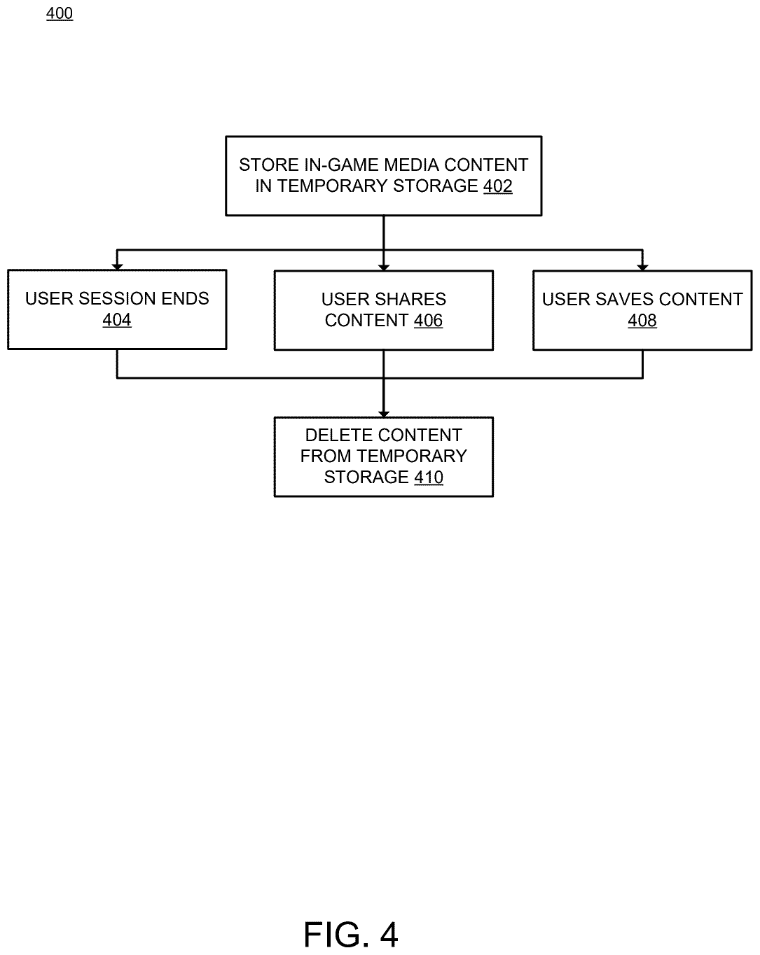

FIG. 4 is a flowchart of a method 400 to manage the storage and deletion of in-game media content, in accordance with some implementations. Method 400 may begin at block 402.

At block 402, in-game media content may be stored in a temporary storage. As discussed herein, the temporary storage may be integrated with a user device or may be hosted by a virtual environment or a memory of a developer. Such in-game media content may include one or more captured screenshots, a video clip (which may or may not be accompanied by audio), and so on. As noted herein, the content may be stored in the temporary storage initially and then transferred to persistent storage (such as a persistent storage associated with a user device). Block 402 may be followed by block 404, block 406, or block 408.

At block 404, a user session ends. A user session may end for a variety of reasons. For example, the user may request that a session end. Alternatively or additionally, the user session may be ended automatically. For example, a user session may end automatically after a total time period or a period of inactivity.

Alternatively or additionally, the user session may be ended automatically if a user takes certain actions, even if the user's does not specifically request to end the session. For example, if a user takes an action, such as uttering an inappropriate word, that is violative of in-game policies, the user may be forcibly removed from the user session and the temporary in-game media content that was stored in the temporary content for that user may be suitable for removal. The content to delete may be limited to content associated with a specific experience. Such an action indicates that it may be appropriate to remove in-game content associated with that user session from the temporary storage. Block 404 may be followed by block 410.

At block 406, a user shares content. If the user shares content, that involves the in-game content being copied for use by another user from the temporary storage. This implies that the content no longer has to be stored in the persistent storage, given that it may be implied that sharing indicates that the user is done with the content. Such an action indicates that it may be appropriate to remove in-game content associated with the sharing from the temporary storage. Block 406 may be followed by block 410.

At block 408, a user saves content. If the user saves content, that involves the user copying the in-game content to a corresponding persistent storage for that user or to another persistent storage (for example, a persistent storage provided by another user or a persistent storage provided by the virtual environment) from the temporary storage.

Such an action indicates that it may be appropriate to remove in-game content associated with the saving from the temporary storage. This implies that the content no longer has to be stored in the persistent storage, given that it may be implied that saving indicates that the user is done with the content. Such an action indicates that it may be appropriate to remove in-game content associated with the saving from the temporary storage. Block 408 may be followed by block 410.

At block 410, the in-game media content is deleted from the temporary storage. Block 410 may be proceeded by one (or more) of block 404, block 406, and/or block 408. In these blocks, a user session ends, a user shares the content, and/or the user saves the content, as discussed herein. The occurrence of one or more of these events signals that it is permissible to delete the content from the temporary storage. Thus, FIG. 4 illustrates that taking certain actions (for example, ending a user session, sharing content, saving content) indicates that it is no longer necessary to retain the content, and hence the content is deleted.

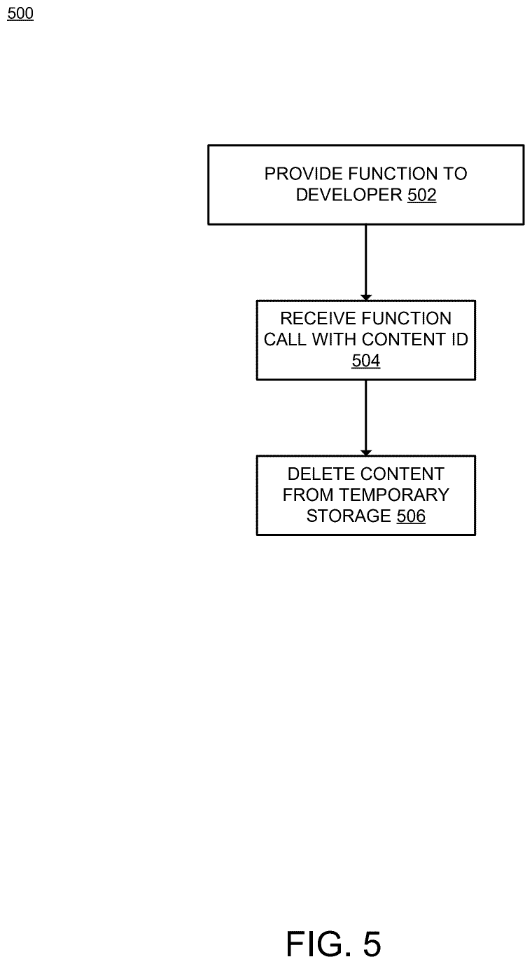

FIG. 5 is a flowchart of a method 500 to permit a developer to delete in-game media content from a temporary storage of a user device, in accordance with some implementations. Method 500 may begin at block 502.

At block 502, a function is provided to a developer. Such a function permits the developer to remove pieces of in-game media content from a user device at arbitrary times, other than at times at which the in-game media content overflows the capacity of the temporary storage. The function may be provided as part of an API for managing the capturing of in-game media content. Because the developer may have a good understanding of which in-game media content is unused or otherwise lower priority, providing such a function to a developer may permit manual management of content in a temporary storage before memory pressure occurs. Thus, this function operates without detecting overflow. Block 502 may be followed by block 504.

At block 504, a function call with a content ID as its parameter is received. Such a function call may be received wherever the temporary storage is hosted, whether the temporary storage is hosted at the user device or elsewhere. Block 504 may be followed by block 506.

At block 506, content is deleted from the temporary storage. Specifically, the temporary storage uses the content ID of the content to access the in-game media content in the temporary storage. The function call then instructs the temporary storage to delete the accessed in-game media content.

If the developer wishes to delete additional in-game media content, the developer may return to block 502 after block 506 is performed. That is, a developer is permitted to delete an arbitrary amount of in-game media content from the temporary storage, until the temporary storage is completely empty and there is no remaining in-game media content to delete.

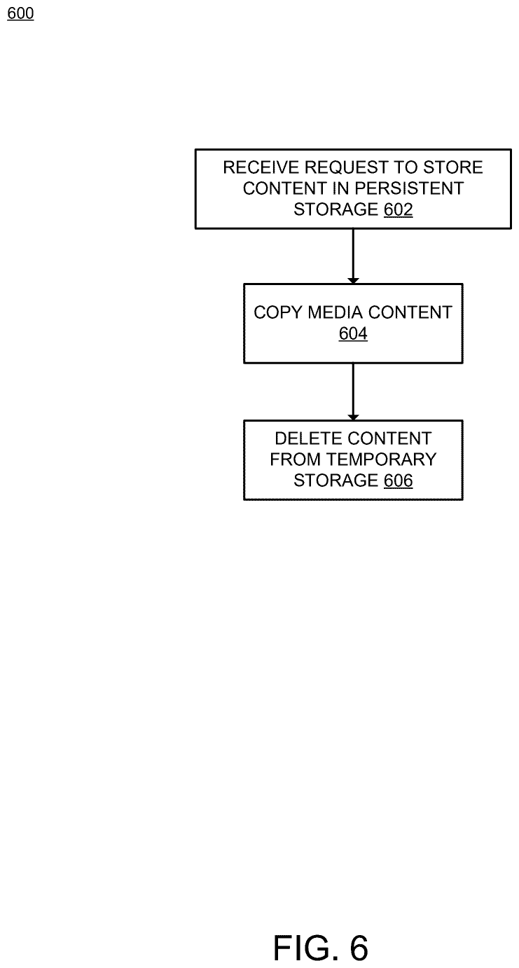

FIG. 6 is a flowchart of a method 600 to permit a user to move in-game media content from a temporary storage of a user device to a persistent storage of the user device, in accordance with some implementations. While method 600 is described in some example implementations in which both the temporary storage and the persistent storage are provided by the user device, other implementations may provide the temporary storage elsewhere, such as at a designated portion of the virtual environment, such as a memory. Method 600 may begin at block 602.

At block 602, a request to store content in persistent storage is received from a user. Such a request may be received at the user device. For example, the content may be in-game media content stored in a temporary storage, such as a temporary storage provided by a user device of the user or provided elsewhere. While the temporary storage is characterized in some implementations as being provided by a user device, the temporary storage may be provided in other ways. Block 602 may be followed by block 604.

At block 604, the in-game media content is copied from the temporary storage of the user device to the persistent storage of the user device. For example, the temporary storage and the persistent storage may be in communication with one another, and the temporary storage may send the in-game media content for storage in persistent storage. Various techniques may be used to copy the data in the in-game media content. Block 604 may be followed by block 606.

At block 606, the in-game content is deleted from temporary storage. Such deletion may occur when the in-game media content is fully copied. Alternatively or additionally, the in-game media content deletion may occur over a period of time. For example, block 604 may copy the in-game media content to the persistent storage as a series of packets. Once the arrival of each packet (or a set of packets) is confirmed and/or acknowledged, that packet may be deleted from the temporary storage.

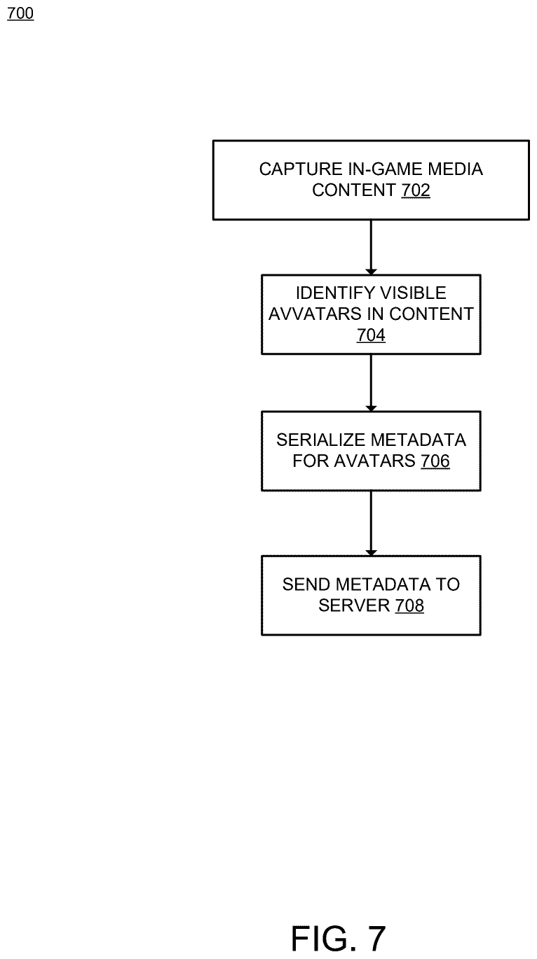

FIG. 7 is a flowchart of a method 700 to identify and store information about avatars present in in-game media content, in accordance with some implementations. Method 700 may begin at block 702.

At block 702, in-game media content is captured. Such in-game media content may include screenshots and/or video (with or without audio). For example, a user may prompt a user device to work with a virtual experience to capture in-game media content within the virtual experience. Block 702 may be followed by block 704.

At block 704, visible avatars are identified in the content. There may be various functionality provided by the virtual environment to identify avatars in screenshots taken in virtual experiences. These techniques may be extended to videos. For example, videos could be transformed into screenshots taken at sampling intervals, and the techniques may be applied to those screenshots to detect avatars and movement of the avatars. Block 704 may be followed by block 706.

At block 706, metadata is serialized for the avatars. Serialization is the process of converting an object's state into a savable format. For example, the metadata may correspond to a humanoid description object for the avatars as defined by the virtual environment. Such a humanoid description object may store the visual appearance of a character, including clothing, accessories, body part colors, and animations.

Using the humanoid description object permits developers to save and apply custom avatar looks to characters, making it useful for cloning players, creating non-player character (NPC) appearances, or managing character outlines within a game. It is possible to load such a humanoid description object onto a humanoid docus to provide a visual appearance of the character. Such metadata has to be saved for every capture. Block 706 may be followed by block 708.

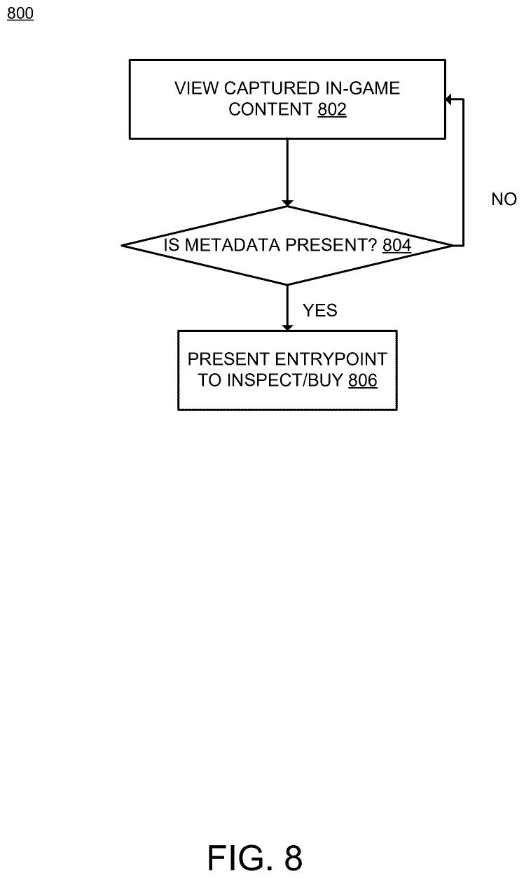

At block 708, the metadata is sent to a server. The server then has access to information about the avatars the server manages. Once the metadata is sent to the server, the metadata may be subsequently accessed in method 800, as discussed in FIG. 8.

FIG. 8 is a flowchart of a method 800 to use stored information about avatars to provide inspect/buy functionality, in accordance with some implementations. Method 800 may begin at block 802.

At block 802, captured in-game media content is viewed. For example, a user may look at a screenshot captured previously, such as captured at block 702. Block 802 may be followed by block 804.

At block 804, it is determined if metadata is present. Such metadata is discussed further in the discussion of FIG. 7. If not, block 804 is followed by block 802 and additional captured in-game media content is viewed. If so, and there is such metadata present, block 804 is followed by block 806.

At block 806, an entry point to inspect/buy is presented for a given avatar. For example, an entry point to inspect/buy is presented for one or more avatars identified from the captured in-game media content. The entry point may provide a way to inspect/buy. For example, the inspect features may permit a user to inspect aspects of the current humanoid description object.

As discussed, the humanoid description object stores the visual appearance of a character, including clothing, accessories, body part colors, and animations. Thus, inspect features permit a user (a user that has chosen to inspect the avatar in the screenshot) to get more information about these features and to make certain modifications to these aspects.

The buy features are related to the inspect features but involve the expenditure of in-game currency (or real-world currency, such as a natural currency to make certain modifications to the aspects of the avatar governed by the humanoid description object). For example, the user may be provided with an interface (such as an electronic or online store) that permits the user to make payments to change aspects related to the appearance of the avatar. For example, the interface could permit the user to purchase clothing for an avatar and dress the avatar.

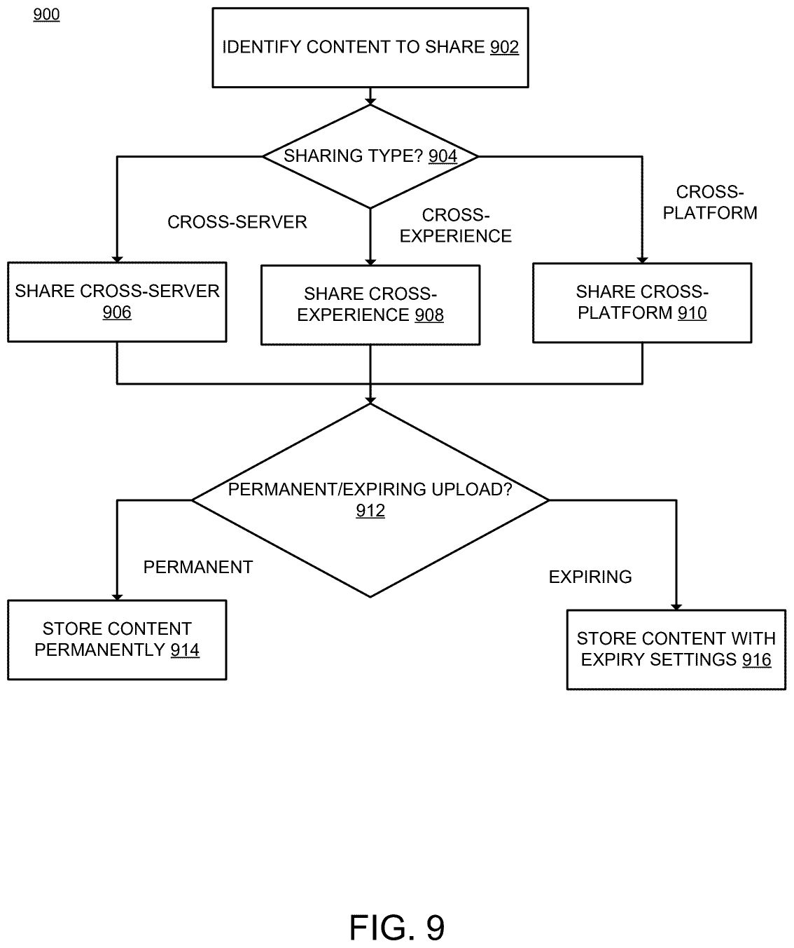

FIG. 9 is a flowchart of a method 900 to manage sharing of stored content across different participants, in accordance with some implementations. Method 900 may begin at block 902.

At block 902, in-game media content to be shared is identified. As discussed, such in-game media content may be a screenshot or a video (with or without audio). Block 902 may be followed by block 904.

At block 904, a type of sharing is identified. An aspect of content sharing as presented in FIG. 9 is that there may be cross-server sharing, in which users share content to other users in the same game server. Another aspect of content sharing is that there may cross-experience sharing, in which users can share content across a given experience. Another aspect of content sharing is that there may be cross-platform sharing, in which users can share content captured in multiple experiences on the platform (that is, the virtual environment).

If the sharing is cross-server, block 904 is followed by block 906. If the sharing is cross-experience, block 904 is followed by block 908. If the sharing is cross-platform, block 904 is followed by block 910.

At block 906, cross-server sharing occurs. To enable content sharing for users in the same game server, it may be possible to share content by passing content from the client to the game server to another client. This approach is less complex than uploading the captures to the platform, due to storing images for the lifetime of the game server.

This approach may present certain issues with respect to sharing video, given the potentially large bandwidth limitations. To ensure that sharing works for any content (screenshots or video), captures may be uploaded to a network of distributed servers for distribution of the content. For example, there could be an upload function provided, which could take an original content ID of the source and a result function that provides a Boolean value corresponding to Block 906 may be followed by block 912.

At block 908, cross-experience sharing occurs. Cross-experience sharing may be implemented in ways similar to that of cross-server sharing, except that certain changes may be made to moderation and content lifetime features. Block 908 may be followed by block 912.

At block 910, cross-platform sharing occurs. Again, this may occur using the network of distributed servers. Block 910 may be followed by block 912.

At block 912, it is determined if the shared content is a permanent upload or an expiring upload. If the shared content is a permanent upload, block 912 is followed by block 914. If the shared content is an expiring upload, block 912 is followed by block 916.

At block 914, the shared content is a permanent upload. In this case, the sharing performed in block 908, block 910, or block 912 may sufficient. While the shared content may be deleted, the shared content does not automatically expire after a set period of time elapses.

At block 916, the shared content may be assigned a lifetime when the shared content is stored. Such a lifetime may be chosen to successfully manage storage constraints and may be modified as appropriate. Given such content, it may be possible to provide functionality to check the lifetime of the content using a content ID, such as by returning an expiry date or other expiry setting associated with the content.

FIG. 10 is a block diagram that illustrates an example computing device 1000 which may be used to implement one or more features described herein, in accordance with some implementations. In one example, computing device 1000 may be used to implement a computer device (e.g., server 102 and/or client device 110 of FIG. 1), and perform appropriate method implementations described herein. Computing device 1000 can be any suitable computer system, server, or other electronic or hardware device. For example, the computing device 1000 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1000 includes a processor 1002, a memory 1004, input/output (I/O) interfaces 1006, and audio/video input/output devices 1014.

Processor 1002 can be one or more processors and/or processing circuits to execute program code and control basic operations of the computing device 1000. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in computing device 1000 for access by the processor 1002, and may be any suitable processor-readable storage medium (e.g., random access memory (RAM), read-only memory (ROM), electrical erasable read-only memory (EEPROM), flash memory, etc.), suitable for storing instructions for execution by the processor, and located separate from processor 1002 and/or integrated therewith. Memory 1004 can store software operating on the computing device 1000 by the processor 1002, including an operating system 1008, a virtual experience application 1010, an in-game media content management application 1012, and other applications (not shown). In some implementations, virtual experience application 1010 and/or in-game media content management application 1012 can include instructions that enable processor 1002 to perform the functions (or control performance of the functions) described herein (e.g., some or all of the methods described with respect to FIGS. 3-9).

For example, virtual experience application 1010 (which can be embodied by the virtual experience application 112 or 132 of FIG. 1) can include an in-game media content management application 1012, which as described herein can manage in-game media content within an online virtual experience server (e.g., 102). Elements of software in memory 1004 can alternatively be stored on any other suitable storage location or computer-readable medium. In addition, memory 1004 (and/or other connected storage device(s)) can store instructions and data used in the features described herein. Memory 1004 and any other type of storage (magnetic disk, optical disk, magnetic tape, or other tangible media) can be considered “storage” or “storage devices.”

I/O interface(s) 1006 (which can be embodied by the I/O interface 114 of FIG. 1, for example) can provide functions to enable interfacing the computing device 1000 with other systems and devices. For example, network communication devices, storage devices (e.g., memory and/or data store 120), and input/output devices can communicate via I/O interface(s) 1006. In some implementations, the I/O interface(s) 1006 can connect to interface devices including input devices (keyboard, pointing device, touchscreen, microphone, camera, scanner, etc.) and/or output devices (display device, speaker devices, printer, motor, etc.).

The audio/video input/output devices 1014 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 10 shows one block for each of processor 1002, memory 1004, I/O interface(s) 1006, and software blocks of operating system 1008, virtual experience application 1010, and in-game media content management application 1012. These blocks may represent one or more processors or processing circuitries, operating systems, memories, I/O interfaces, applications, and/or software engines. In other implementations, computing device 1000 may not have all of the components shown and/or may have other elements including other types of elements instead of, or in addition to, those shown herein. While the online virtual experience server 102 is one example of the computing device 1000 that is described as performing operations as described in some implementations herein, any suitable component or combination of components of online virtual experience server 102 or other device/system, or any suitable processor or processors associated with such a system, may perform or control performance of the operations described.

A user device can also implement and/or be used with features described herein. Example user devices can be computer devices including some similar components as the computing device 1000 (e.g., processor(s) 1002, memory 1004, and I/O interface(s) 1006). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 1014, for example, can be connected to (or included in) the computing device 1000 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device, e.g., voice output or synthesis that speaks text.

One or more methods described herein (e.g., methods 300, 400, 500, 600, 700, 800, and 900) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to capture and manage storage of in-game media content in a virtual experience, the method comprising:
receiving, at a user device, a request to capture the in-game media content while an avatar associated with a user of the user device participates in the virtual experience;
capturing the in-game media content on the user device, wherein the captured in-game media content is associated with a temporary content identifier (ID) and includes one or more pieces of the in-game media content;
storing the captured in-game media content in a temporary storage of the user device, the temporary storage configured to provide a storage location to store the captured in-game media content until the user of the user device instructs the user device to store the captured in-game media content in a persistent storage of the user device;
detecting an overflow of a storage capacity of the temporary storage of the user device;
in response to detecting the overflow of the storage capacity, prompting a developer to select a particular piece of the captured in-game media content to remove from the temporary storage wherein the developer selection is via a callback function that has as a parameter a content ID of the particular piece of the captured in-game media content to remove;
in response to receiving developer selection of the particular piece of the captured in-game media content to remove, removing the particular piece of the captured in-game media content from the temporary storage using the content ID of the particular piece of the captured in-game media content to access the particular piece of the captured in-game media content when removing the particular piece of the captured in-game media content; and
in response to no developer selection in response to the prompting, automatically selecting the particular piece of the captured in-game media content to remove and removing the particular piece of the captured in-game media content from the temporary storage.

2. The computer-implemented method of claim 1, further comprising:
performing additional iterations of prompting and removing at least one other piece of the captured in-game media content until the temporary storage of the user device does not overflow the storage capacity.

3. The computer-implemented method of claim 1, wherein the particular piece of the captured in-game media content comprises a screenshot of a display screen of the user device captured while the user of the user device participates in the virtual experience.

4. The computer-implemented method of claim 1, wherein the particular piece of the captured in-game media content comprises a video file that includes captured video of a display screen of the user device and associated audio captured while the user of the user device participates in the virtual experience.

5. The computer-implemented method of claim 4, wherein the video file is deleted from the temporary storage after a user session of the virtual experience ends, the user shares the video file, or the user saves the video file.

6. The computer-implemented method of claim 1, wherein the automatically selecting the particular piece of the captured in-game media content to remove is based on respective durations for which individual pieces of in-game media content are present in the temporary storage.

7. The computer-implemented method of claim 6, wherein the particular piece of the captured in-game media content has a longest duration from among the respective durations for which individual pieces of in-game media content are present in the temporary storage.

8. The computer-implemented method of claim 1, wherein the automatically selecting the particular piece of the captured in-game media content to remove is based on respective access times for which individual pieces of in-game media content are accessed from the temporary storage.

9. The computer-implemented method of claim 1, further comprising providing a function to the developer that takes a content ID of a piece of the captured in-game media content as a parameter without detecting the overflow and removes the piece of the captured in-game media content corresponding to the content ID.

10. The computer-implemented method of claim 1, further comprising:
receiving a request from the user of the user device to store a first piece of the captured in-game media content in a persistent storage of the user device;
copying the first piece of the captured in-game media content from the temporary storage to the persistent storage; and
after the copying, removing the first piece of the captured in-game media content from the temporary storage.

11. A non-transitory computer-readable medium with instructions stored thereon that, responsive to execution by a processing device, causes the processing device to perform or control performance of operations to capture and manage storage of in-game media content in a virtual experience, the operations comprising:
receiving, at a user device, a request to capture the in-game media content while an avatar associated with a user of the user device participates in the virtual experience;
capturing the in-game media content on the user device, wherein the captured in-game media content is associated with a temporary content identifier (ID) and includes one or more pieces of the in-game media content;
storing the captured in-game media content in a temporary storage of the user device, the temporary storage configured to provide a storage location to store the captured in-game media content until the user of the user device instructs the user device to store the captured in-game media content in a persistent storage of the user device;
detecting an overflow of a storage capacity of the temporary storage of the user device;
in response to detecting the overflow of the storage capacity, prompting a developer to select a particular piece of the captured in-game media content to remove from the temporary storage wherein the developer selection is via a callback function that has as a parameter a content ID of the particular piece of the captured in-game media content to remove;
in response to receiving developer selection of the particular piece of the captured in-game media content to remove, removing the particular piece of the captured in-game media content from the temporary storage using the content ID of the particular piece of the captured in-game media content to access the particular piece of the captured in-game media content when removing the particular piece of the captured in-game media content; and
in response to no developer selection in response to the prompting, automatically selecting the particular piece of the captured in-game media content to remove and removing the particular piece of the captured in-game media content from the temporary storage.

12. The non-transitory computer-readable medium of claim 11, wherein the operations further comprise:
performing additional iterations of prompting and removing at least one other piece of the captured in-game media content until the temporary storage of the user device does not overflow the storage capacity.

13. The non-transitory computer-readable medium of claim 11, wherein the particular piece of the captured in-game media content comprises a screenshot of a display screen of the user device captured while the user of the user device participates in the virtual experience.

14. The non-transitory computer-readable medium of claim 11, wherein the particular piece of the captured in-game media content comprises a video file that includes captured video of a display screen of the user device and associated audio captured while the user of the user device participates in the virtual experience.

15. The non-transitory computer-readable medium of claim 14, wherein the video file is deleted from the temporary storage after a user session of the virtual experience ends, the user shares the video file, or the user saves the video file.

16. A system comprising:
a memory with instructions stored thereon; and
a processing device, coupled to the memory, the processing device configured to access the memory and execute the instructions, wherein the instructions cause the processing device to perform or control performance of operations to capture and manage storage of in-game media content in a virtual experience, the operations comprising:
receiving, at a user device, a request to capture the in-game media content while an avatar associated with a user of the user device participates in the virtual experience;
capturing the in-game media content on the user device, wherein the captured in-game media content is associated with a temporary content identifier (ID) and includes one or more pieces of the in-game media content;
storing the captured in-game media content in a temporary storage of the user device, the temporary storage configured to provide a storage location to store the captured in-game media content until the user of the user device instructs the user device to store the captured in-game media content in a persistent storage of the user device;
detecting an overflow of a storage capacity of the temporary storage of the user device;
in response to detecting the overflow of the storage capacity, prompting a developer to select a particular piece of the captured in-game media content to remove from the temporary storage wherein the developer selection is via a callback function that has as a parameter a content ID of the particular piece of the captured in-game media content to remove;
in response to receiving developer selection of the particular piece of the captured in-game media content to remove, removing the particular piece of the captured in-game media content from the temporary storage using the content ID of the particular piece of the captured in-game media content to access the particular piece of the captured in-game media content when removing the particular piece of the captured in-game media content; and
in response to no developer selection in response to the prompting, automatically selecting the particular piece of the captured in-game media content to remove and removing the particular piece of the captured in-game media content from the temporary storage.

17. The system of claim 16, wherein the operations further comprise:
performing additional iterations of prompting and removing at least one other piece of the captured in-game media content until the temporary storage of the user device does not overflow the storage capacity.

18. The system of claim 16, wherein the particular piece of the captured in-game media content comprises a screenshot of a display screen of the user device captured while the user of the user device participates in the virtual experience.

19. The system of claim 16, wherein the particular piece of the captured in-game media content comprises a video file that includes captured video of a display screen of the user device and associated audio captured while the user of the user device participates in the virtual experience.

20. The system of claim 19, wherein the video file is deleted from the temporary storage after a user session of the virtual experience ends, the user shares the video file, or the user saves the video file.
